(19) United States
(12) Patent Application Publication
(10) Pub. No.: US 2003/0070831 A1
(43) Pub. Date: Apr. 17, 2003

(54) Communications cable

(76) Inventor: Martin Frederick Arthur Hudson, Hampshire (GB)

Correspondence Address: HESLIN ROTHENBERG FARLEY & MESITI PC, 5 COLUMBIA CIRCLE, ALBANY, NY, 12203, US

(21) Appl. No.: 10/179,923

(22) Filed: Jun. 24, 2002

Related U.S. Application Data
(63) Continuation of application No. PCT/GB00/04992, filed on Dec. 22, 2000.

(30) Foreign Application Priority Data
Dec. 24, 1999 (GB) 9930509.6

(51) Int. Cl. H01B 7/00

(52) U.S. Cl. 174/113 R

(57) ABSTRACT

The invention provides a communications cable comprising a plurality of cores (4) through which communications signals can be transmitted, each core comprising a metallic conductor (6) surrounded by a close-fitting sleeve (8) of insulating material which is substantially free of halogenated polymers, the insulating material having a permittivity of no greater than 3, and comprising an outer layer (8′″) of a non-foamed polymer surrounding a layer (8″) of foamed polymer, the outer layer (8′″) containing a fire retardant, the layer of foamed polymer optionally surrounding a layer (8′) of non-foamed polymer, and wherein the region of the insulating material immediately adjacent the metallic conductor (6) contains no fire retardant metal hydroxide and/or carbonate filler; an outer cable sheath (16) disposed radially outwardly of and surrounding the cores, the outer cable sheath (16) constituting a fire protection layer and being formed from an extrudable polymer containing a fire retardant material such as a metal hydroxide and/or carbonate filler; and optionally a metallic or metallised screening layer disposed between the cores and the outer cable sheath; but provided that no additional fire protection layer is disposed between the cores and the outer cable sheath (16).

This invention relates to a communications cable, and more particularly to a fire resistant communications cable.

### BACKGROUND OF THE INVENTION

Communications cables, such as cables used in telephone lines, typically consist of insulated copper cores, the layer surrounding the copper being formed from an insulating polymeric material. The insulated cores may be arranged in the form of twisted pairs or quads and a plurality of twisted pairs or quads may be bundled together and encased within an outer polymeric layer. A screening layer can be interposed between the bundled cores and the outer layer to serve as an earth.

One problem facing the manufacturers of cables is that the polymeric materials from which cables are formed represent a possible means by which fires can be transmitted through a building because commonly used polymers such as polyolefins (e.g. polyethylene or polypropylene) can be highly flammable in a fire situation. It is therefore known to make cables from a fire resistant material.

One test used to determine the fire resistance of cables is the so called Steiner Tunnel test (American National Standards Institute ANSI UL 910/NFPA 262). The purpose of this test is to determine the flame-propagation distance and optical smoke density for electrical cables that are to bc installed in ducts, plenums and other communications spaces and channels within buildings. This test is effectively mandatory in the USA for cables which are to be installed in buildings.

The test involves mounting the cable in a specially designed tunnel or chamber and subjecting the cable to a test fire fuelled by methane gas. An observer then monitors the propagation of the flame along the cable and a photoelectric cell is used to monitor the density of the smoke created by the resulting fire. In order to meet the requirements of the test, the following criteria must be satisfied:

(a) The maximum flame propagation distance must not be greater than 5 feet (152 cm) beyond the initial test flame.

(b) The peak optical density of the smoke produced is to be 0.50 or less (32% light transmission).

(c) The average optical density of the smoke produced is to be 0.15 or less.

Polymeric insulating materials typically used for covering copper cores in electrical and communications cables include polyolefins such as polyethylene and polypropylene, which are highly flammable in fire situations. In order to overcome this problem, it has been proposed to use as the insulating polymer, a polymer composition which has better fire resistance or fire retardant properties. This approach is exemplified by DE-C-3044871 which discloses a cable in which individual metal conductors are covered with a layer of a fire retardant filled polyvinylchloride.

EP-B-0107796 discloses an optical communications cable in which the optical fibre is encased in a sheath or layer of a fire retardant polyolefin copolymer such as EVA filled with a metal hydroxide, an outer sheath of a similar fire retardant polymer also being provided.

EP-B-0526081 discloses electric and communications cables in which a tape of flexible mineral material is wrapped around the core, the tape being adhesively bonded to an outer layer of a fire retardant filled polymer which forms a char when exposed to a fire situation. The purpose of bonding the tape to the outer layer is to ensure that the char remains as a cohesive protective layer and does not fill away from the cable.

EP-0268827 discloses a fire-resistant electrical cable comprising a conductor surrounded by an insulating layer which in turn is surrounded by a tape-wrap layer which can be formed from metal, woven glass fibre, polyimide, polyimidine, or aromatic polyamide tape having an adhesive on its inner surface.

DE-A-3833597 discloses a fire resistant cable comprising a conductor surrounded by a thin layer of high temperature resistant polymer such as a polyesterimide, a polyetherimide, a polyamidimide or a polyimide, and a thicker outer layer of a non-high temperature stable polymer which is filled with a substance such a aluminium hydroxide.

WO-A-96/25748 discloses a fire resistant cable construction in which the conductor is surrounded by an inner layer of a foamed polymeric material such as polyolefin, a polyolefin copolymer or a polyurethane which preferably contains a fire retarding agent such as magnesium hydroxide. The inner layer in turn is surrounded by a halogenated polymeric layer which also contains a fire retardant additive such as magnesium hydroxide.

U.S. Pat. No. 4,810,835 discloses a coaxial cable in which the conductor is surrounded sequentially by concentric layers of an insulating material, a screening layer, a metallised fibre glass cloth layer and an outer layer of an insulating material.

GB-A-2128394 discloses an electrical cable in which the metal conductor is surrounded by a polymeric insulating material which is filled with inorganic fire retardant agents such as aluminium trihydrate and antimony pentoxide.

U.S. Pat. No. 5,841,072 discloses a communications cable comprising a metallic conductor surrounded by insulation in which the inner layer of the insulation is a foamed layer and the outer layer is a layer of fluorinated ethylenepropylene polymers (FEP).

Of fundamental importance to the acceptability of communications cables are the electrical properties of the cable, and the typical properties that communications cables should possess are summarised in WO-A-96/25748. One important property is the dielectric constant or permittivity of the insulating material surrounding the conductor wire, which is a measure of the insulating capability of the material. In general, the higher the permittivity of the insulating material the thicker the insulating material needs to be in order to provide the required characteristic impedance.

The permittivity of polyethylene is approximately 2.3 which makes it an excellent insulating material but, as pointed out above, polyethylene is flammable. Replacing polyethylene with polymer compositions containing fire retarding agents, as disclosed in the documents referred to above, whilst potentially offering improved fire resistance, would be detrimental to the electrical properties and in particular would lead to increased permittivity and therefore the required size of the core.

In order to provide improved fire resistance properties without sacrificing the electrical properties of the insulating material, fluorinated ethylene-propylene polymers (FEP) have been used as the insulation materials for metal conductors. Bundled FEP cores encased within an outer cable sheath formed from a filled fire resistant polymer are understood to have passed the Steiner Tunnel Test; indeed, it is understood by the present applicants that cables of such construction are the only communications cables to have passed the test prior to the present invention being made. However, a major problem with FEP, as stated in WO-A-96/140 25748. is that it is expensive and often in short supply. Moreover, it is understood that the thermal breakdown products of such fluorinated polymers are toxic.

It is clearly undesirable from a manufacturer's view for the basic raw materials for its products to be difficult and expensive to obtain. It is also undesirable to use a material where the breakdowvn products of the polymer are toxic fluorine-containing gases.

U.S. Pat. No. 5,670,748 discloses a cable core construction which avoids the need to use FEP and which includes a halogenated polymeric outer layer, and a foamed polymeric inner layer surrounding the metal conductor.

U.S. Pat. No. 5,841,073 discloses a cable core construction in which the requirement for FEP is reduced through the expedient of forming the insulating layers of some of the cable cores from FEP but forming the remainder from a polyolefin containing no fire retardant.

Our earlier application, WO-A-98/45855 discloses a screened non-coaxial communications cable comprising:

a plurality of cores through which communications signals can be transmitted, each core comprising a metallic conductor surrounded by a close-fitting sleeve of insulating material which is substantially free of halogenated polymers, the insulating material having a permittivity of no greater than 3, and being constituted by or containing a layer of foamed polymer, and wherein at least in the region of the insulating material immediately adjacent the metallic conductor, the polymer contains no fire retardant metal hydroxide and/or carbonate filler;

a first fire protection layer disposed radially outwardly of and surrounding the plurality of cores, the first fire protection layer comprising a fabric formed from inorganic fibres;

a second fire protection layer disposed radially outwardly of and surrounding the first fire protection layer, the second fire protection layer being formed from an extrudable polymer containing a fire retardant metal hydroxide and/or carbonate filler, the first and second fire protection layers not being adhesively bonded together; and

a metallic or metallised screening layer disposed between the cores and the second fire protection layer.

Cables of this type are disclosed as having satisfied the requirements of the Steiner Tunnel test described above.

### SUMMARY OF THE INVENTION

It has now unexpectedly been found that cables lacking the first (i.e. intermediate) fire protection layer disclosed in WO-A-98/45855 can have good fire resistance and can pass the Steiner Tunnel test.

Accordingly, in a first aspect, the invention provides a communications cable (preferably a non-coaxial cable) comprising a plurality of cores through which communications signals can be transmitted, each core comprising a metallic conductor surrounded by a close-fitting sleeve of insulating material which is substantially free of halogenated polymers, the insulating material having a permittivity of no greater than 3, and comprising an outer layer of a non-foamed polymer surrounding a layer of foamed polymer, the outer layer containing a fire retardant, the layer of foamed polymer optionally surrounding a layer of non-foamed polymer, and wherein the region of the insulating material immediately adjacent the metallic conductor contains no fire retardant metal hydroxide and/or carbonate filler; an outer cable sheath disposed radially outwardly of and surrounding the cores, the outer cable sheath constituting a fire protection layer and being formed from an extrudable polymer containing a fire retardant material such as.a metal hydroxide and/or carbonate filler; and optionally a metallic or metallised screening layer disposed between the cores and the outer cable sheath; but provided that no additional fire protection layer is disposed between the cores and the outer cable sheath.

The communications cables of the invention can be screened or unscreened.

The communications cable of the invention comprises a core through which communications signals can be transmitted. The core comprises a metallic conductor surrounded by a layer of insulating material the insulating material having a permittivity of no greater than 3.

The sleeve of insulating material surrounding the metallic conductor is substantially free of halogenated polymers. The term “substantially free of halogenated polymers” as used in this specification means that no halogen can be detected by means of DEC Test Methods 60754/1 and 60754/2.

It has unexpectedly been found that by using a combination of an outer sheath of a fire resistant filled polymer (e.g. containing a metal hydroxide or carbonate filler), and a foamed core in which the outer layer of the core is made fire retardant (for example by containing fire retardant materials such as metal oxides or hydroxides), it is possible to maintain the fire resistance properties of the cable without needing to use fluorinated polymers as the insulation material for the metal conducting cores of the cable, or without needing an intermediate fire protection layer.

It is most preferred that the fire resistance properties of the cable are such that the maximum flame propagation distance of the cable, as measured by American National Standards Institute test ANSI UL 910, is less than 152 cm beyond an initial test flame.

It is further most preferred that the peak optical density of the smoke produced by the cable, as measured by American National Standards Institute test ANSI UL 910, is less than 0.5 and the average optical density of the smoke is 0.15 or less.

The outer sheath is typically formed from an extrudable polymer containing a fire retardant metal hydroxide and/or carbonate filler such as aluminium hydroxide, alkaline earth metal hydroxides or carbonates such as magnesium hydroxide, calcium carbonate or magnesium carbonate, or mixtures thereof. The metal hydroxide/carbonate filler will usually be present in an amount corresponding to 10 to 100 parts by weight per 100 parts of the extrudable polymer, more usually 20 to 50 parts per 100 parts of polymer, for example 35 to 45 parts per 100 parts of the polymer. In a preferred embodiment, the metal hydroxide/carbonate filler is present in an amount corresponding to approximately 40 parts per 100 parts of the polymer.

The extrudable polymer can be a chlorinated polymer such as polyvinylchloride (PVC), or a non-halogenated polymer, for example a polyolefin such as polyethylene or polypropylene, or an ethylene or propylene copolymer such as ethylene-vinyl acetate (EVA). The extrudable polymer may contain a plasticiser, which may be present at relatively high levels. For example, the plasticiser can be present in an amount corresponding to between 10 and 60 parts by weight per 100 parts of polymer. More usually the plasticiser will be present in an amount corresponding to 40 to 50 parts by weight, for example approximately 45 parts by weight, per 100 parts of the polymer.

One group of preferred plasticisers are the phosphate plasticisers, for example polyphosphates such as melamine polyphosphate or ammonium polyphosphate.

In addition to the metal hydroxide/carbonate filler and plasticiser, the extrudable polymer can contain auxiliary fire retardant materials such as antimony compounds (e.g. antimony trioxide and antimony halides) and fire retardant bromine compounds, one preferred example of an auxiliary fire retardant compound being antimony bromide.

Examples of commercially available polymeric materials suitable for use as second fire protection layer are the “Smokeguard III 8512” and “Smokeguard IV 6001” materials manufactured by the AlphaGary Corporation of Leominster Mass., USA.

In general a communications cable will comprise a plurality of cores. Each of the cores will have an insulating layer and the insulated cores typically will be arranged in the form of one or more twisted pairs or quads. For example, there may be two, three, four, five or more twisted pairs or quads, and in one preferred embodiment there are four such twisted pairs. For each twisted pair or quad, the lay length or pitch of the wires will be substantially constant along its length and, in order to minimise “cross-talk” between adjacent pairs or quads, the lay lengths or pitches of adjacent twisted pairs or quads in a bundle will be different.

The metallic conductor is typically formed from copper or silver or tin coated copper. Each metallic conductor is insulated in a polymeric insulating material.

The layer of insulating material of the core preferably is formed from polyolefins such as polyethylene or polypropylene, and the polyolefin advantageously comprises a combination of a radially inner foam layer and a radially outer non-foamed layer or a combination of a radially inner non-foamed layer, an intermediate foamed layer, and a radially outer non-foamed layer. The radially outer layer is provided with fire retardant properties, for example by virtue of containing one or more fire retardant agents as hereinbefore defined. The fire retardant is preferably substantially halogen free. An example of a suitable fire retardant polymer is a filled polyolefin available from the AlphaGary Corporation under the trade name HF 8030.

The advantage of providing a foamed polyolefin layer is that the gas bubbles in the foam reduce the permittivity of the material thereby enabling thinner layers of insulating material to be used.

A screening layer can be interposed between the core or cores and the outer cable sheath, preferably together with a drain wire or conductor to allow the screening layer to be earthed at either end when the cable is installed and to compensate for any breaks or discontinuities in the screening layer. The screening layer is typically a metallic or metallised screening layer which can be formed for example from a metallised polymer film. For example, the screening layer can comprise a polymer film (such as a polyester film) coated with aluminium.

The screening layer is advantageously in the form of a tape, which is most preferably longitudinally wrapped, although it may instead be helically or spirally wrapped.

When a screening layer is employed, an insulating or protective layer (e.g. in the form of a tape) formed from a polymer such as a polyolefin or a polyester may optionally be interposed between the screening layer and the cores. The insulating layer inter alia helps to prevent the drain wire (if present) from damaging the insulating material of the cores.

Alternatively, or additionally, individual cores or individual groups of cores (e.g. pairs or quads) may be separated from other individual cores or groups of cores by a separator extending along the length (i.e. axially) of the cable. The separator can be formed from a polymeric material, preferably a halogen free polymeric material, which can advantageously be metallised. A metallised screening layer may surround the separator such that when the separator is metallised, the separator together with the screening layer from a plurality of enclosures for each of the individual cores or groups of cores. The separator can, for example, have a star-shaped cross sectional profile or a cruciform cross sectional profile, and can be configured as described in, for example, U.S. Pat. No. 5,952,615.

The invention will now be illustrated, but not limited, by reference to the particular embodiments shown in the accompanying drawings.

### BRIEF DESCRIPTION OF THE DRAWINGS

FIG. 1 is a view of an end of a cable according to one embodiment of the invention in which the various layers have been cut away to reveal the structure of the cable.

FIG. 2 is an enlarged longitudinal sectional view of the region marked A in FIG. 2.

FIG. 3 is a cross-sectional view through a cable comprising a plurality of twisted pairs separated by a separator extending along the length of the cable.

FIG. 4 is a cutaway view of an end of a cable similar to the cable of FIG. 1 but having screening and insulating layers between the outer cable sheath and the cores.

### DETAILED DESCRIPTION OF THE PREFERRED EMBODIMENTS

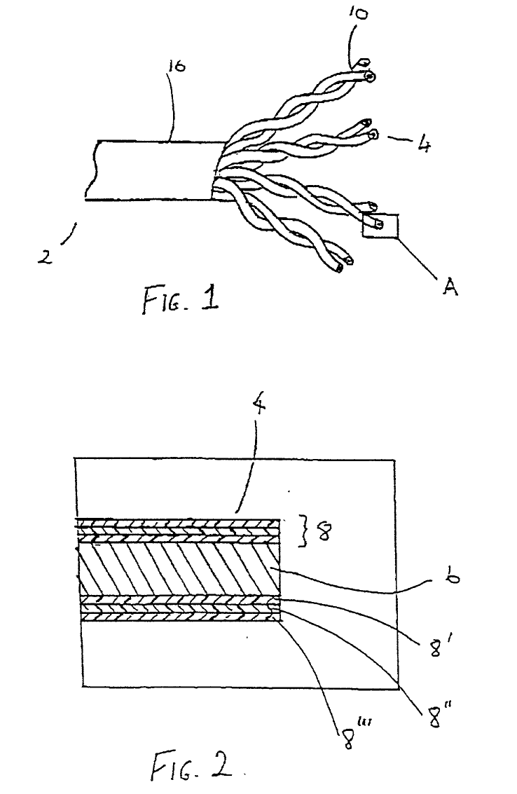

Referring now to FIGS. 1 and 2, a cable 2 according to one embodiment of the invention comprises a plurality of cores 4 through which electronic communications signals can be transmitted. Each core consists of a copper wire 6 surrounded by a layer 8 of a polyolefin (in this case polyethylene) insulating material. The polyolefin layer is of substantially uniform thickness along its length and is concentrically arranged with respect to the wire 6. The concentricity of the insulating layer and its relatively uniform thickness means that the spacing between the wires in the pairs or quads remain substantially uniform throughout the length of the cable thereby ensuring a substantially constant characteristic impedance. The structure of the layer 8 is shown more clearly in FIG. 2 from which it can be seen that the layer has a radially inner layer 8′ of a non-foamed polyolefin, an intermediate layer 8″ of a foamed polyolefin, and a radially outer layer of a non-foamed polyolefin 8′″. The advantage of the foamed layer, as indicated above is that the gas bubbles within the foam have reduced permittivity relative to the solid polymer thereby enabling the overall thickness of the insulation layer to be reduced. The polyolefin (e.g. polyethylene or polypropylene) is layered onto the wire 6 by means of a combination of extruders and the foamed layer is formed by introducing nitrogen or another inert gas into the polyolefin before extruding onto the wire 6. The introduction of nitrogen or another inert gas can be accomplished in a number of ways, for example by direct injection of the gas into the molten polymer, or by thermal decomposition of a precursor compound that releases nitrogen upon heating. The outer layer 8′″ contains fire retardant materials.

In the embodiment shown there are eight cores in total, arranged in four twisted pairs 10, each of the four pairs 10 having a different number of turns per unit length (different pitch) in conventional fashion in order to minimise lateral transmission of signals (“cross-talk”) between adjacent pairs of cables.

Surrounding the bundle of pairs is the outer cable sheath 16 which is in the form of an extruded layer of a fire resistant polymer which in this embodiment is a filled polyvinylchloride (PVC). In order to provide fire resistance, the polymer is typically filled with 40 parts of metal hydroxide, which is either aluminium trihydroxide or magnesium hydroxide or a mixture of the two, per hundred parts of the PVC. The PVC also typically contains 45 parts of a phosphate plasticiser and 0.5 parts of an antimony bromide fire retarding agent per 100 parts of the PVC. A suitable filled polymer is the “Smokeguard III 8512” material available from the AlphaGary Corporation in Massachusetts USA, or AlphaGary PLC, Syston, UK.

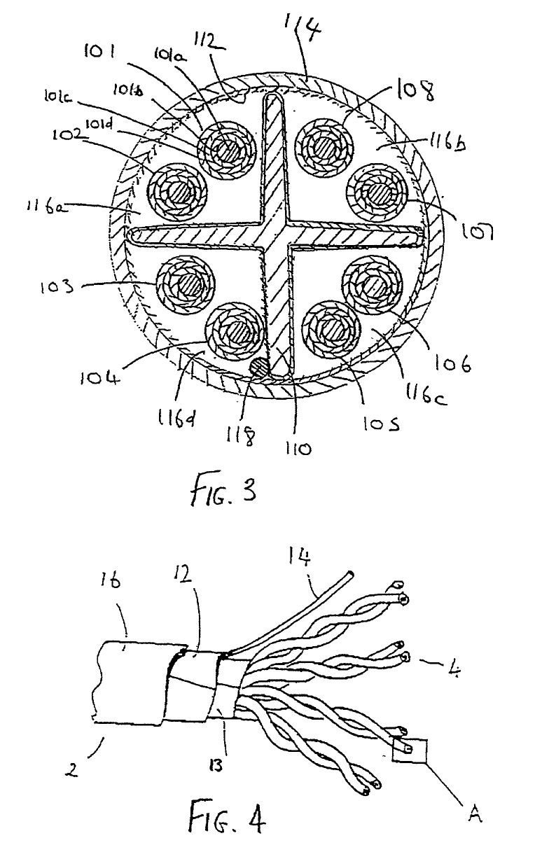

FIG. 3 illustrates an alternative embodiment in which four twisted pairs 101/102, 103/104, 105/106 and 107/108 are separated by a cruciform separator 110 which extends for the length of the cable. The separator can be formed from an extruded low smoke polymer such as the AlphaGary SmokeGuard O-201 polymer, or a fluorinated polymer, and is coated with a metallic layer formed by treatment of the separator with a silver alloy in a solvent. The separator is enclosed within a wrap 112 of a metallised screening tape (aluminised polyester) which in turn is enclosed by the outer cable sheath 114 which is formed from a low smoke vinyl alloy polymer. The metallised wrap 112 is in firm contact with the separator 110 thereby forming four compartments 116a, 116b, 116c, and 116d, each of which is fully screened. A tin- or silver-coated copper drain wire 118 extends along the cable through compartment 116d.

Each of the cores making up the twisted pairs has a structure, illustrated with reference to core 101, consisting of a central copper conductor wire of 0.57 mm nominal diameter surrounded in sequence by an inner skin layer 101b (approximate thickness 12 microns) of a solid polyethylene, an intermediate layer 101c (approximate thickness 300 microns) of a foamed polyethylene and an outer layer 101d (approximate thickness 80 microns) of a fire retarded halogen free polyolefin alloy.

The Cable shown in FIG. 1 is an unscreened cable. FIG. 4 shows a cable similar in most respects to the cable of FIG. 1 but having screening and insulating layers between the outer cable sheath and the cores.

Thus, in the cable of FIG. 4, surrounding the twisted pairs 10 is a layer 12 of an aluminised polyester tape which functions as an earth or screening layer preventing extraneous electrical signals from interfering with signals passing along the cable. The screening layer 12 can be, for example, up to about 100 micrometres in thickness, and a suitable grade of material is a material having a composite thickness of 62 micrometres (50 micrometres aluminium and 12 micrometres polyester) available from Polifibra. In order to ensure continuity and to compensate for any breaks in the screening layer 12, a conductor or drain wire 14 formed from silver- or tin-coated copper is provided. The drain wire 14 can be connected to earth at both ends of the cable during installation. The copper wire 14 is coated with silver or tin in order to prevent a galvanic corrosion action taking place between the alumninium of the screening layer and the copper. In order to protect the cable cores against damage by the drain wire, a thin tape 13 of an insulating polymer such as a polyester is positioned between the screening layer 12 and the cores. The polyester tape can be, for example of 12 to 25 micrometers in thickness.

It will readily be apparent that numerous modifications and alterations can be made to the cables illustrated above without departing from the principles underlying the invention and all such modifications and alterations are intended to be embraced by this application.

1. A communications cable comprising a plurality of cores through which communications signals can be transmitted, each core comprising a metallic conductor surrounded by a close-fitting sleeve of insulating material which is substantially free of halogenated polymers, the insulating material having a permittivity of no greater than 3, and comprising an outer layer of a non-foamed polymer surrounding a layer of foamed polymer, the outer layer containing a fire retardant which is substantially halogen free, the layer of foamed polymer optionally surrounding a layer of non-foamed polymer, and wherein the region of the insulating material immediately adjacent the metallic conductor contains no fire retardant metal hydroxide and/or carbonate filler; an outer cable sheath disposed radially outwardly of and surrounding the cores, the outer cable sheath constituting a fire protection layer and being formed from an extrudable polymer containing a fire retardant material such as a metal hydroxide and/or carbonate filler; and optionally a metallic or metallised screening layer disposed between the cores and the outer cable sheath; but provided that no additional fire protection layer is disposed between the cores and the outer cable sheath.

2. A communications cable according to claim 1 which is non-coaxial.

3. A communications cable according to claim 1 or claim 2 wherein the said outer layer of non-foamed polymer is formed from an olefin polymer, copolymer or a polyolefin alloy.

4. A communications cable according to any one of the preceding claims wherein the maximum flame propagation distance of the cable, as measured by American National Standards Institute test ANSI UL 910, is less than 152 cm beyond an initial test flame.

5. A communications cable according to any one of the preceding claims wherein the peak optical density of the smoke produced by the cable, as measured by American National Standards Institute test ANSI UL 910, is less than 0.5 and the average optical density of the smoke is 0.15 or less.

6. A communications cable according to any one of the preceding claims which is unscreened.

7. A communications cable according to any one of claims 1 to 5 which is screened.

8. A communications cable according to any one of the preceding claims wherein the insulating material surrounding each metallic conductor comprises a radially inner foam layer and a radially outer non-foamed layer.

9. A communications cable according to any one of claims 1 to 7 wherein the insulating material comprises a radially inner non-foamed layer, an intermediate foamed layer, and a radially outer non-foamed layer.

10. A communications cable according to any one of the preceding claims wherein the outer non-foamed layer contains a metal hydroxide and/or metal carbonate fire retardant.

11. A communications cable according to any one of the preceding claims wherein the insulating material of the core is a polyolefin such as polyethylene or polypropylene.

12. A communications cable according to any one of the preceding claims wherein the cores are arranged in the form of one or more twisted pairs or quads.

13. A communications cable according to claim 12 wherein the cores are arranged in the form of a plurality of twisted pairs or quads.

14. A communications cable according to claim 13 wherein there are present from one to thirty twisted pairs or quads.

15. A communications cable according to claim 14 wherein there are present four twisted pairs.

16. A communications cable according to any one of the preceding claims wherein a screening layer is interposed between the cores and the outer cable sheath.

17. A communications cable according to any one of claims 1 to 15 wherein each core, twin or quad is individually wrapped in a screening layer.

18. A communications cable according to claim 17 wherein the plurality of individually wrapped cores, twins or quads form a bundle and the bundle is surrounded by a second metallic or metallised screening layer.

19. A communications cable according to any one of claims 16 to 18 wherein the screening layer is formed from a metallised polymer film.

20. A communications cable according to claim 19 wherein the polymer film is coated with aluminum.

21. A communications cable according to claim 19 or claim 20 wherein the polymer film is formed from a polyester.

22. A communications cable according to any one of claims 16 to 21 wherein a drain wire is interposed between the core or cores and the outer cable sheath so as to be in contact with the screening layer.

23. A communications cable according to any one of claims 1 to 15 wherein individual cores, or individual groups of cores such as twisted pairs or quads, are separated by an axially extending separator.

24. A communications cable according to claim 23 wherein the separator is formed from a polymeric material.

25. A communications cable according to claim 23 or claim 24 wherein the separator is surrounded by a metallised screening layer.

26. A communications cable according to any one of claims 23 to 25 wherein the separator is metallised.

27. A communications cable according to claim 26 wherein the separator is surrounded by a metallised screening layer which is in contact with the separator such that each twisted pair or quad is enclosed by a metallised screen defined by the screening layer and the metallised separator.
